(19) United States
(12) Patent Application Publication
(10) Pub. No.: US 2017/0058547 A1
(43) Pub. Date: Mar. 2, 2017

(54) Systems and Methods for Remote Tower Implementation

(71) Applicant: Maple Mountain Composites, Mapleton, UT (US)

(72) Inventors: Craig Alan Barker, Mapleton, UT (US); Michael David Ridges, Mapleton, UT (US); Kyle Alan Barker, SR., Mapleton, UT (US)

(21) Appl. No.: 15/238,710

(22) Filed: Aug. 16, 2016

Related U.S. Application Data
(60) Provisional application No. 62/211,358, filed on Aug. 28, 2015.

(51) Int. Cl. E04H 12/16; B29D 23/00; E04H 12/34; B29C 70/06; E04C 3/36; E04H 12/02

(52) U.S. Cl. CPC E04H 12/16; E04C 3/36; E04H 12/02; E04H 12/342; B29C 70/06; B29D 23/00; B29K 2105/06

(57) ABSTRACT

The present inventions relate generally to tower systems, utility poles, and power transmission poles; and more particularly to a structure and method for implementing such poles and towers.

### CROSS REFERENCE TO RELATED APPLICATION

The present application claims priority to (i.e., is a non-provisional of) U.S. Pat. App. No. 62/211,358 entitled “Multi-Material Composite Pole”, and filed Aug. 28, 2015 by Barker et al. The entirety of the aforementioned application is incorporated herein by reference for all purposes.

### BACKGROUND OF THE INVENTION

The present inventions relate generally to tower systems, utility poles, and power transmission poles; and more particularly to a structure and method for implementing such poles and towers.

Masts used in the erection of towers, utility poles, power transmission poles, and other construction projects must offer great stability and durability. To this end, the state of the art has been to construct such towers and poles from steel or wood. However, use of such materials result in a combination of components that together are heavy, heavy, cumbersome, and difficult to transport. To address this, some attempts have been made to construct poles from lighter composite materials, however such attempts have failed due to overly complicated and expensive tooling and materials.

For at least the aforementioned reasons, there exists a need in the art for more advanced pole and tower components and systems.

### BRIEF SUMMARY OF THE INVENTION

The present inventions relate generally to tower systems, utility poles, and power transmission poles; and more particularly to a structure and method for implementing such poles and towers.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a tower system constructed of multi-layered pole structures in accordance with various embodiments of the present inventions;

FIG. 2 depicts a single multi-layered pole structure that is tapered in accordance with one or more embodiments of the present inventions;

FIG. 3 shows a two-layer pole structure in accordance with some embodiments of the present inventions;

FIG. 4 illustrates a three-layer pole structure where the three layers are repeated to form a six-layer pole structure in accordance with some embodiments of the present inventions;

FIG. 5 shows a pole made of one or more multi-layered pole structures, and having a metal accessory mounted to the pole in accordance with particular embodiments of the present inventions;

FIG. 6 is a flow diagram showing a method for manufacturing a multi-layered pole structure in accordance with various embodiments of the present inventions; and

FIG. 7 is a flow diagram showing a method for implementing a pole using two or more multi-layered pole structure in accordance with some embodiments of the present inventions.

### DETAILED DESCRIPTION OF THE INVENTION

The present invention is related to monitoring movement, and in particular to systems and methods for supporting target monitoring.

Various embodiments of the present inventions provide pole components that include two or more different fibrous materials formed within layers in a polymer matrix (resin) to remedy current weight, handling, and corrosion limitations while maintaining structural integrity.

Various embodiments provide pole structures that include a tube formed of at least a first composite material layer defining an outer surface of the tube and a second composite material layer defining an inner surface of the tube. The first composite material layer is formed of a first composite material and the second composite material layer is formed of a second composite material. The first composite material is a glass fiber material. The second composite material may be one of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, or a sixth hybrid materials including at least aramid fibers and glass fibers.

In some instances of the aforementioned embodiments, the carbon fiber material is a carbon fiber reinforced resin, the boron fiber material is a boron fiber reinforced resin, the aramid fiber material is an aramid fiber reinforced resin, and the glass fiber material is a glass fiber reinforced resin. In various instances of the aforementioned embodiments, the pole structure further includes at least one intermediate layer between the first composite layer and the second composite layer. The at least one intermediate layer is formed of a third composite material that may be one of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, or a sixth hybrid materials including at least aramid fibers and glass fibers.

In one or more instances of the aforementioned embodiments, the tube is tapered from a top of the tube to a bottom of the tube. In some such instances, the tube exhibits a flared region near the bottom of the tube. In other instances of the aforementioned embodiments, the tube is cylindrical in shape. In some such instances, the tube exhibits a flared region near a bottom of the cylindrically shaped tube.

Other embodiments provide pole kits that include at least a first pole structure, a second pole structure, and a set of instructions. Both the first pole structure and the second pole structure are a tube formed of at least a first composite material layer defining an outer surface of the tube and a second composite material layer defining an inner surface of the tube, where the first composite material layer is formed of a first composite material and the second composite material layer is formed of a second composite material. The first composite material is a glass fiber material. The second composite material may be one of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, or a sixth hybrid materials including at least aramid fibers and glass fibers.

In various instances of the aforementioned embodiments, the pole kit further includes a metal mounting bracket capable of being attached to at least one of the first pole structure and the second pole structure such that a metal portion of the metal mounting bracket is in contact with the first composite material layer. In some instances of the aforementioned embodiments, the first pole structure is connectable to the second pole structure such that the connected first pole structure and second pole structure makes a pole assembly. In some cases, the first pole structure and the second pole structure are identical.

In some instances of the aforementioned embodiments, the carbon fiber material is a carbon fiber reinforced resin, the boron fiber material is a boron fiber reinforced resin, the aramid fiber material is an aramid fiber reinforced resin, and the glass fiber material is a glass fiber reinforced resin. In various instances of the aforementioned embodiments, both the first pole structure and the second pole structure further include at least one intermediate layer between the first composite layer and the second composite layer. The at least one intermediate layer is formed of a third composite material that may be one of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, or a sixth hybrid materials including at least aramid fibers and glass fibers.

In one or more instances of the aforementioned embodiments, the tube is tapered from a top of the tube to a bottom of the tube. In some such instances, the tube exhibits a flared region near the bottom of the tube such that a top portion of the second pole structure mates to a bottom portion of the first pole structure to form a pole assembly. In other instances of the aforementioned embodiments, the tube is cylindrical in shape. In some such instances, the tube exhibits a flared region near a bottom of the cylindrically shaped tube such that a top portion of the second pole structure mates to a bottom portion of the first pole structure to form a pole assembly.

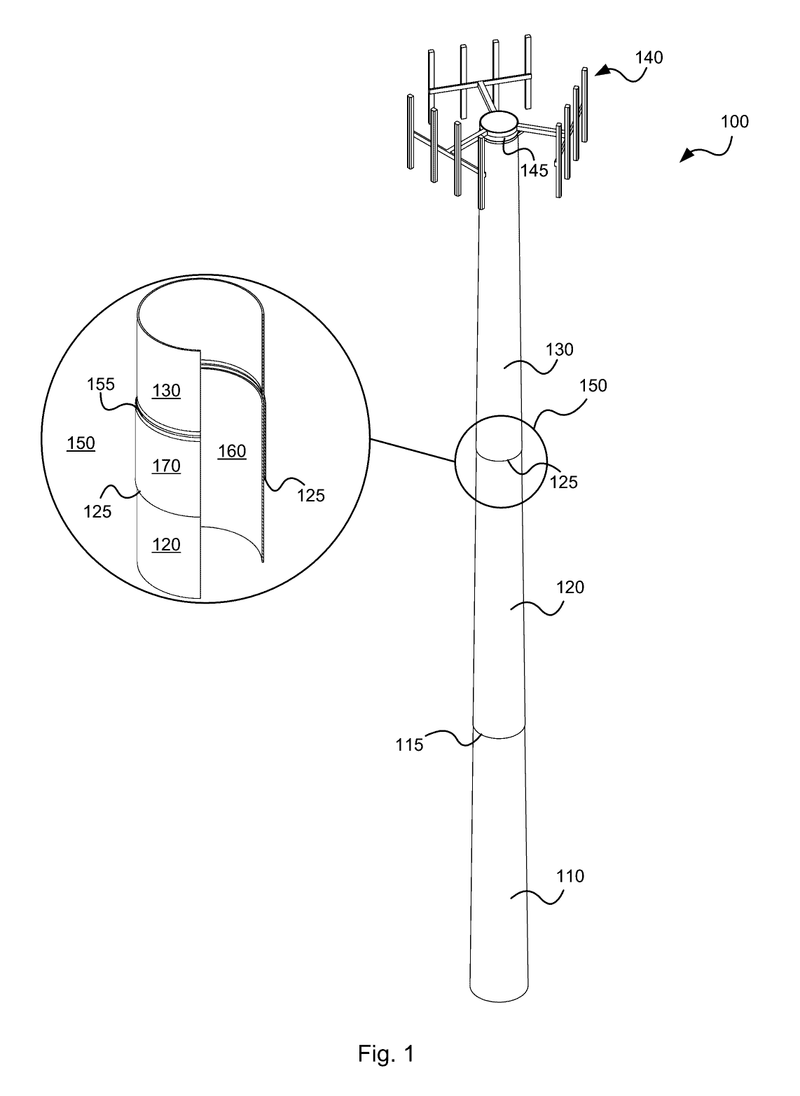

Turning to FIG. 1, a tower system 100 is depicted that is constructed of three multi-layered pole structures 110, 120, 130 in accordance with various embodiments of the present inventions. An antenna array 140 is mounted atop tower system 100 using a mounting bracket 145 that wraps around pole structure 130. Pole structure 110 is connected to pole structure 120 at a joint 115, and pole structure 120 is connected to pole structure 130 at a joint 125.

An expanded view 150 of joint 125 is shown where a portion of pole structure is cut away to show an interior region 160 defined as an area within an inner surface of pole structures 110, 120, 130. In some embodiments, a base of pole structure 130 is flared at a lower region 170. Lower region 170 begins where a bottom portion of pole structure 130 extends out 155 and continues until the bottom of pole structure 130 which corresponds to the location indicated for joint. Such a flare allows for easy assembly of tower system 100 including two or more pole structures designed to be installed atop one another. In the embodiment shown, a kit may be provided that includes all of pole structures 110, 120, 130. In the embodiment, each of the pole structures is progressively tapered from the bottom to the top. In such an embodiment, the top of pole section 110 has a circumference that is greater than that of the top of pole section 120; and the top of pole section 120 has a circumference that is greater than that of the top of pole section 130. In such a case, the kit of pole structures 110, 120, 130 includes three different pole structures designed for assembly in a particular order from bottom to top.

It should be noted that while embodiments herein are shown as being based upon tapered pole structures, that in other embodiments the pole structures are not tapered, but do include a flare joint similar to that shown in expanded view 150. In such a case, a kit of pole structures may include a number of pole structures that are interchangeable and may be assembled from bottom to top in any desired order.

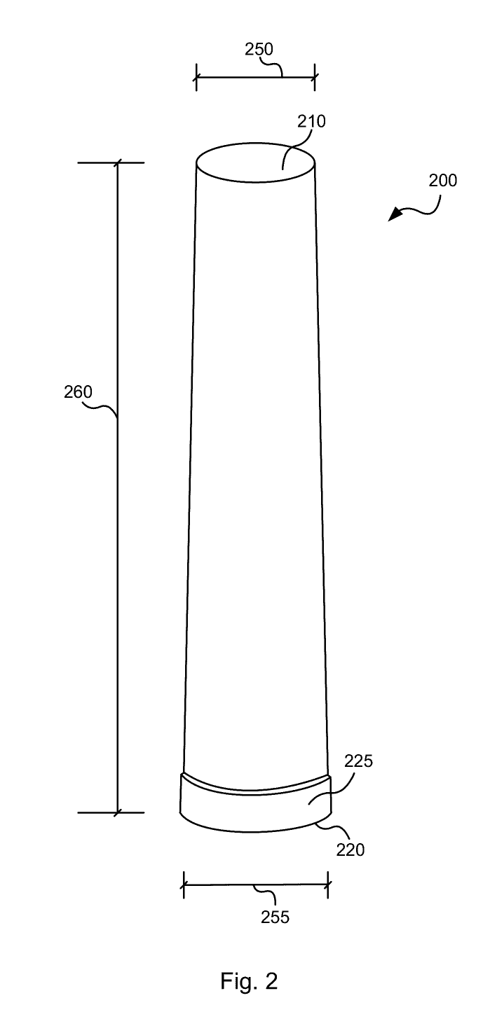

Turning to FIG. 2, a single multi-layered pole structure 200 is shown that is tapered in accordance with one or more embodiments of the present inventions. As shown, the shape of pole structure 200 is generally cylindrical. A top 210 of pole structure 200 exhibits a diameter 250 that is smaller than a diameter 255 of a bottom of pole structure 200 such that pole structure exhibits a taper along its height 260.

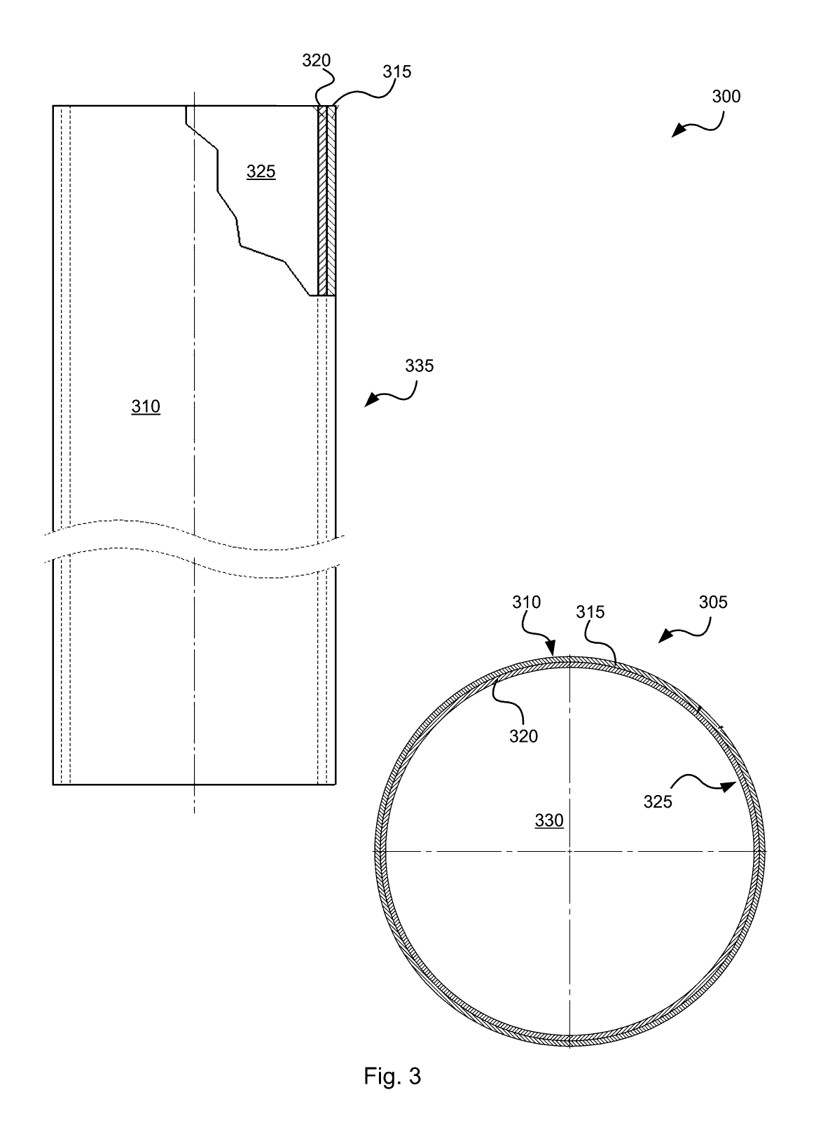

Turning to FIG. 3, a cut-away side view 335 and a cross-sectional view 310 are provided of a two-layer pole structure 300 in accordance with some embodiments of the present inventions. As shown, two-layer pole structure 300 includes an outer layer 310 and an inner layer 325, and is formed in a generally cylindrical shape leaving a void 330 in a center area circumscribed by inner layer 325. Two-layer pole structure 300 is formed of a first composite layer 315 formed over a second composite layer 320. Second composite layer 320 may be formed of a first composite material that provides a desired weight/strength ratio. First composite layer 315 may be formed of a second composite material that provides both a desired weight/strength ratio, and also is compatible with metal accessories that may be mounted to a pole made of two or more two-layer pole structures 300. First composite layer 315 and second composite layer 320 are integral to each other such that one or more desired physical characteristics such as high strength, rigidity, impact resistance, corrosion resistance, and weight are achieved.

In some embodiments, first composite layer 320 may be, but is not limited to, a carbon fiber material, a glass fiber material, an aramid fiber material, a boron fiber material, and any hybrid of the aforementioned materials. The carbon fiber material may be, for example, a carbon fiber reinforced resin; the glass fiber material may be, for example, a glass fiber reinforced resin; the boron fiber material may be, a boron fiber reinforced resin; and the aramid fiber material may be an aramid fiber reinforced resin. Similarly, second composite layer 315 may be, but is not limited to, a carbon fiber material, a glass fiber material, an aramid fiber material, a boron fiber material, and any hybrid of the aforementioned materials. In some particular embodiments, first composite layer 315 is formed of a glass fiber material such as, for example, fiber glass that does not exhibit a high degree of chemical reactivity with metal including, but not limited to, galvanic corrosion. In addition to reducing chemical reactivity with metals, use of a glass fiber material for first composite layer 315, use of such a glass fiber material provides resistance to physical impacts. In those same embodiments, second composite layer 320 is formed of one of a carbon fiber material, an aramid fiber material, a boron fiber material, and a combination material including one or more of carbon fibers, glass fibers, aramid fibers and boron fibers. In one particular embodiment, first composite layer 315 is formed of a glass fiber material and second composite layer 320 is formed of a carbon fiber material.

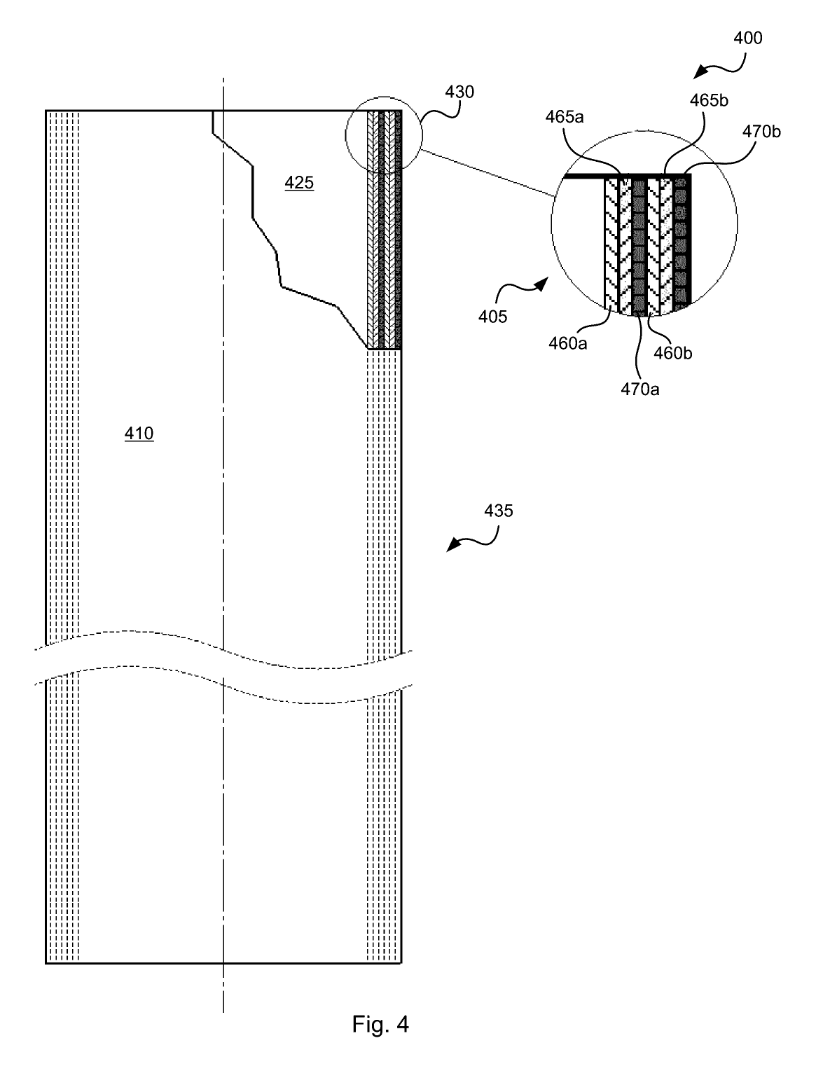

Turning to FIG. 4, a cut-away side view 435 and an expanded view 405 of a layer stack 430 are provided of a six-layer pole structure 400 in accordance with some embodiments of the present inventions. An outer surface 410 of pole structure 400 is formed of an outer composite layer 470b, and an inner surface 425 of pole structure 400 is formed of an inner composite layer 460a. Four other composite layers (a first composite layer 465a, a second composite layer 470a, a third composite layer 460b, and a fourth composite layer 465b are formed between inner composite layer 460a and outer composite layer 470b as shown in expanded view 405. As shown, inner composite layer 460a and third composite layer 460b are formed of the same material; first composite layer 465a and fourth composite layer 465b are formed of the same material; and second composite layer 470a and outer composite layer 470b are formed of the same material. Based upon the disclosure provided herein, one of ordinary skill in the art will recognize other numbers of material layers that may be used in relation to different embodiments of the present invention. Further, based upon the disclosure provided herein, one of ordinary skill in the art will recognize other orders which layers may be ordered. For example, both inner composite layer 460a and outer composite layer 470b may be of one particular material, while the other composite layers 465a, 470a, 460b, 465b may be of different materials from that of inner composite layer 460a and outer composite layer 470b.

Inner composite layer 460a, first composite layer 465a, second composite layer 470a, third composite layer 460b, fourth composite layer 465b and outer composite layer 470b may be formed of composite materials each selected to achieve a desired weight/strength ratio when combined together in pole structure 400, and for outer composite layer 470b, selected to be compatible with metal accessories that may be mounted to a pole made of two or more of pole structures 400.

In some embodiments, inner composite layer 460a may be formed of, but is not limited to, a carbon fiber material, a glass fiber material, an aramid fiber material, a boron fiber material, and any hybrid of the aforementioned materials. The carbon fiber material may be, for example, a carbon fiber reinforced resin; the glass fiber material may be, for example, a glass fiber reinforced resin; the boron fiber material may be, a boron fiber reinforced resin; and the aramid fiber material may be an aramid fiber reinforced resin. Each of composite layers 465a, 470a, 440b, 465b, 470b similarly may be formed of, but are not limited to, carbon fiber materials, glass fiber material, aramid fiber materials, boron fiber materials, and any hybrid of the aforementioned materials.

In some particular embodiments, outer composite layer 470b is formed of a glass fiber material such as, for example, fiber glass that does not exhibit a high degree of chemical reactivity with metal including, but not limited to, galvanic corrosion. In addition to reducing chemical reactivity with metals, use of a glass fiber material for outer composite layer 470b, use of such a glass fiber material provides resistance to physical impacts. In those same embodiments, one or more of inner composite layer 460a, first composite layer 465a, second composite layer 470a, third composite layer 460b, and fourth composite layer 465b is/are formed of a carbon fiber material.

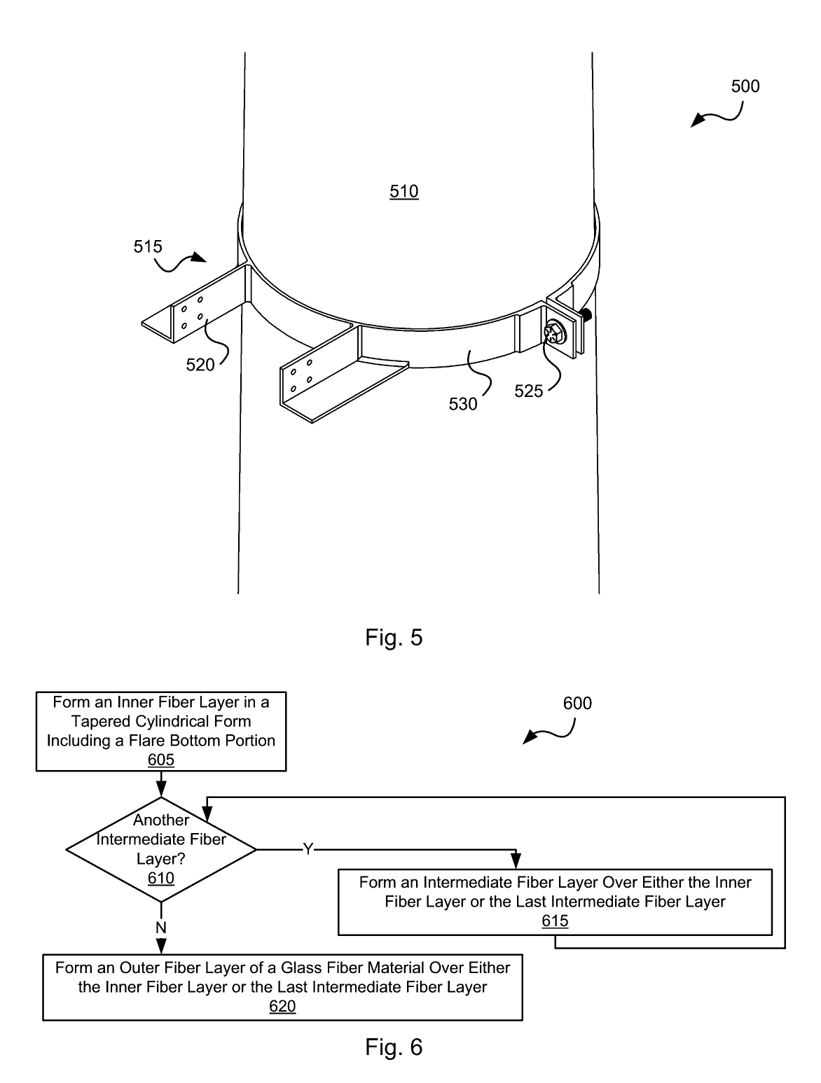

Turning to FIG. 5, a pole 510 made of one or more multi-layered pole structures, and having a metal accessory 515 mounted thereto is shown in accordance with particular embodiments of the present inventions. Metal accessory 515 includes a metal strap portion 530 extending around and in contact with an outer surface of pole 510. Metal strap portion 530 is tightened using a tightening bolt 525, and supports a mounting structure 520. In some embodiments, the outer surface of pole 510 that is in contact with metal strap portion 520 is a fiber glass layer which is relatively nonreactive to the metal of metal strap portion 530 when compared with layers made of, for example, carbon fiber material.

Turning to FIG. 6, a flow diagram 600 shows a method for manufacturing a multi-layered pole structure in accordance with various embodiments of the present inventions. Following flow diagram 600, an inner fiber layer is formed in a tapered cylindrical form including a flare bottom portion (block 605). The tapered cylindrical form with the flared bottom portion may be similar to the shape of pole structure 200 discussed above in relation to FIG. 2. The inner fiber layer forms the general shape of the pole structure. The inner fiber layer may be formed of, but is not limited to, a carbon fiber material, a glass fiber material, an aramid fiber material, a boron fiber material, and any hybrid of the aforementioned materials.

It is then determined whether any intermediate layers will be formed (block 610). An intermediate layer is any layer other than an inner layer and an outer layer of the pole structure. Where an intermediate layer is desired (block 610), an intermediate fiber layer is formed over the inner fiber layer (or over the last intermediate fiber layer where two or more intermediate fiber layers are to be formed) (block 615). The intermediate fiber layer may be formed of, but is not limited to, a carbon fiber material, a glass fiber material, an aramid fiber material, a boron fiber material, and any hybrid of the aforementioned materials.

Where no additional intermediate layers are desired (block 610), an outer fiber layer is formed of a glass fiber material over either the inner fiber layer or the last formed intermediate fiber layer (block 620). By forming the outer fiber layer of a glass fiber material, the resulting pole structure is less reactive to metal structures attached thereto, and less susceptible to physical impacts.

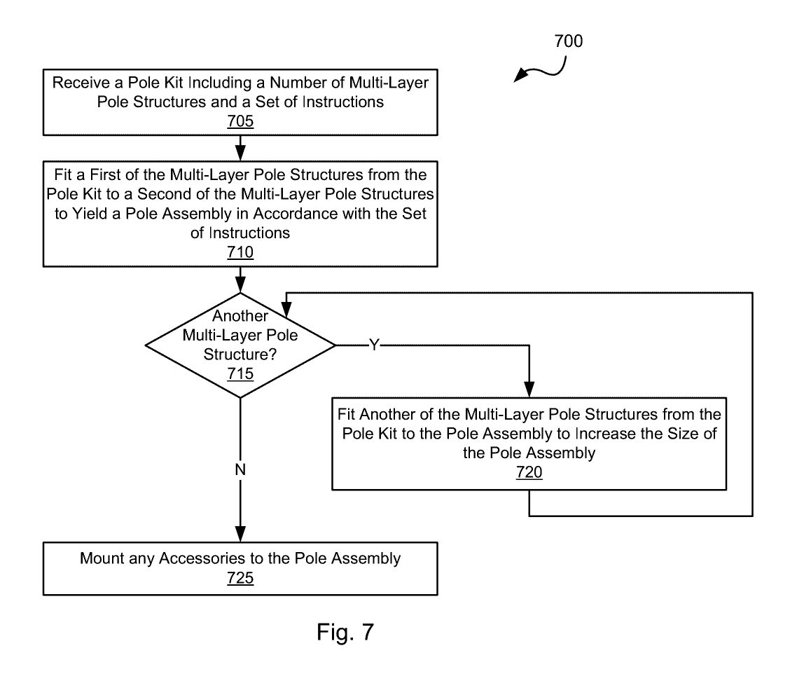

Turning to FIG. 7, a flow diagram 700 shows a method for implementing a pole using two or more multi-layered pole structure in accordance with some embodiments of the present inventions. Following flow diagram 700, a pole kit is received (block 705). The Pole kit includes at least two multi-layer pole structures and a set of instructions. A first multi-layer pole structure from the pole kit is fitted to a second multi-layer pole structure from the same pole kit to yield an pole assembly (block 710). This may include inserting the top of a lower pole structure into a flared bottom end of an upper pole structure. Where the multi-layer pole structures are tapered, the lower pole structure includes an average circumference that is greater than the upper pole structure. In contrast, where the multi-layer pole structures are not tapered, they may be identical.

It is determined whether another multi-layer pole structure is to be used (block 715). Where another multi-layer pole structure is to be used (block 715), another of the multi-layer pole structures from the pole kit is fit to the previously formed pole assembly to increase the length of the pole assembly (block 720). Where all of the multi-layer pole structures have been attached to the pole assembly (block 715), any accessories may be mounted to the pole assembly as part of deploying the pole (block 725).

In conclusion, the present invention provides for novel systems, devices, and methods for implementing pole structures. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A pole structure, the pole structure comprising:
a tube formed of at least a first composite material layer defining an outer surface of the tube and a second composite material layer defining an inner surface of the tube, wherein the first composite material layer is formed of a first composite material and the second composite material layer is formed of a second composite material;
wherein the first composite material is a glass fiber material; and
wherein the second composite material is selected from a group consisting of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, and a sixth hybrid materials including at least aramid fibers and glass fibers.

2. The pole structure of claim 1, wherein the carbon fiber material is a carbon fiber reinforced resin, wherein the boron fiber material is a boron fiber reinforced resin, wherein the aramid fiber material is an aramid fiber reinforced resin, and wherein the glass fiber material is a glass fiber reinforced resin.

3. The pole structure of claim 1, wherein the pole structure further comprises:
at least one intermediate layer between the first composite layer and the second composite layer; and
wherein the at least one intermediate layer is formed of a third composite material selected from a group consisting of: the carbon fiber material, the boron fiber material, the aramid fiber material, the first hybrid material including at least boron fibers and carbon fibers, the second hybrid material including at least boron fibers and aramid fibers, the third hybrid material including at least boron fibers and glass fibers, the fourth hybrid material including at least carbon fibers and aramid fibers, the fifth hybrid material including at least carbon fibers and glass fibers, and the sixth hybrid materials including at least aramid fibers and glass fibers.

4. The pole structure of claim 1, wherein the pole structure further comprises:
at least one intermediate layer between the first composite layer and the second composite layer, wherein the at least one intermediate layer is formed of a third composite material that is the same as the second composite material.

5. The pole structure of claim 1, wherein the pole structure further comprises:
at least one intermediate layer between the first composite layer and the second composite layer, wherein the at least one intermediate layer is formed of a third composite material that is the same as the first composite material.

6. The pole structure of claim 1, wherein the tube is tapered from a top of the tube to a bottom of the tube.

7. The pole structure of claim 6, wherein the tube exhibits a flared region near the bottom of the tube.

8. The pole structure of claim 1, wherein the tube is cylindrical in shape.

9. The pole structure of claim 6, wherein the tube exhibits a flared region near a bottom of the cylindrically shaped tube.

10. A pole kit, the pole kit comprising:
at least a first pole structure, a second pole structure, and a set of instructions;
wherein both the first pole structure and the second pole structure are a tube formed of at least a first composite material layer defining an outer surface of the tube and a second composite material layer defining an inner surface of the tube, wherein the first composite material layer is formed of a first composite material and the second composite material layer is formed of a second composite material;
wherein the first composite material is a glass fiber material; and
wherein the second composite material is selected from a group consisting of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, and a sixth hybrid materials including at least aramid fibers and glass fibers.

11. The pole kit of claim 10, wherein the pole kit further comprises:
a metal mounting bracket capable of being attached to at least one of the first pole structure and the second pole structure such that a metal portion of the metal mounting bracket is in contact with the first composite material layer.

12. The pole kit of claim 10, wherein the first pole structure is connectable to the second pole structure such that the connected first pole structure and second pole structure makes a pole assembly.

13. The pole kit of claim 10, wherein the first pole structure and the second pole structure are identical.

14. The pole kit of claim 10, wherein the carbon fiber material is a carbon fiber reinforced resin, wherein the boron fiber material is a boron fiber reinforced resin, wherein the aramid fiber material is an aramid fiber reinforced resin, and wherein the glass fiber material is a glass fiber reinforced resin.

15. The pole kit of claim 10, wherein both the first pole structure and the second pole structure further comprise:
at least one intermediate layer between the first composite layer and the second composite layer; and
wherein the at least one intermediate layer is formed of a third composite material selected from a group consisting of: the carbon fiber material, the boron fiber material, the aramid fiber material, the first hybrid material including at least boron fibers and carbon fibers, the second hybrid material including at least boron fibers and aramid fibers, the third hybrid material including at least boron fibers and glass fibers, the fourth hybrid material including at least carbon fibers and aramid fibers, the fifth hybrid material including at least carbon fibers and glass fibers, and the sixth hybrid materials including at least aramid fibers and glass fibers.

16. The pole kit of claim 10, wherein the tube is tapered from a top of the tube to a bottom of the tube.

17. The pole kit of claim 16, wherein the tube exhibits a flared region near the bottom of the tube such that a top portion of the second pole structure mates to a bottom portion of the first pole structure to form a pole assembly.

18. The pole kit of claim 10, wherein the tube is cylindrical in shape.

19. The pole kit of claim 18, wherein the tube exhibits a flared region near a bottom of the cylindrically shaped tube such that a top portion of the second pole structure mates to a bottom portion of the first pole structure to form a pole assembly.

20. A method for manufacturing a pole structure, the method comprising:
forming an inner fiber layer in the form of a tube, wherein the inner fiber layer is formed of a first composite material selected from a group consisting of: a carbon fiber material, a boron fiber material, an aramid fiber material, a first hybrid material including at least boron fibers and carbon fibers, a second hybrid material including at least boron fibers and aramid fibers, a third hybrid material including at least boron fibers and glass fibers, a fourth hybrid material including at least carbon fibers and aramid fibers, a fifth hybrid material including at least carbon fibers and glass fibers, and a sixth hybrid materials including at least aramid fibers and glass fibers; and
forming an outer fiber layer over the inner fiber layer, wherein the outer fiber layer is formed of a second composite material, and wherein the second composite material is a glass fiber material.

21. The method of claim 20, wherein the tube is tapered from a top end of the tube to a bottom end of the tube, and wherein the tube exhibits a flared region near the bottom end of the tube.

22. The method of claim 20, wherein the tube is cylindrical, and wherein the tube exhibits a flared region near the bottom end of the tube.
